(19) United States
(12) Patent Application Publication
(10) Pub. No.: US 2013/0149589 A1
(43) Pub. Date: Jun. 13, 2013

(54) ELECTROCHEMICAL CELLS COMPRISING A NITROGEN-CONTAINING POLYMER

(71) Applicants: Oliver GRONWALD, Frankfurt (DE); Klaus Leitner, Ludwigshafen (DE)

(72) Inventors: Oliver GRONWALD, Frankfurt (DE); Klaus Leitner, Ludwigshafen (DE)

(21) Appl. No.: 13/705,599

(22) Filed: Dec. 5, 2012

Related U.S. Application Data
(60) Provisional application No. 61/567,637, filed on Dec. 7, 2011.

(51) Int. Cl. H01M 2/16

(52) U.S. Cl. CPC H01M 2/1673
USPC 429/144; 429/231.95; 429/224; 526/263

(57) ABSTRACT

The present invention relates to electrochemical cells comprising
(A) at least one cathode comprising at least one lithium ion-containing transition metal compound,
(B) at least one anode, and
(C) at least one layer comprising
   (a) at least one polymer comprising monomer units comprising nitrogen-containing 5- or 6-membered heterocyclic aromatic structural units or comprising an organic radical which derives from α-aminophosphonic acid or from iminodiacetic acid, and
   (b) optionally at least one binder.

The present invention further relates to the use of inventive electrochemical cells, and to lithium ion batteries comprising at least one inventive electrochemical cell.

The present invention relates to electrochemical cells comprising
(A) at least one cathode comprising at least one lithium ion-containing transition metal compound,
(B) at least one anode, and
(C) at least one layer comprising
   (a) at least one polymer comprising monomer units comprising nitrogen-containing 5- or 6-membered heterocyclic aromatic structural units or comprising an organic radical which derives from α-aminophosphonic acid or from iminodiacetic acid, and
   (b) optionally at least one binder.

The present invention further relates to the use of inventive electrochemical cells, and to lithium ion batteries comprising at least one inventive electrochemical cell.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

In this context, an important role is played by the materials from which the electrodes are made, and especially the material from which the cathode is made.

In many cases, lithium-containing mixed transition metal oxides are used, especially lithium-containing nickel-cobalt-manganese oxides with layer structure, or manganese-containing spinels which may be doped with one or more transition metals. However a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counterelectrodes. It is believed that these manganese nuclei deposited on the anode, at a potential of less than 1V vs. Li/Li⁺, act as a catalyst for a reductive decomposition of the electrolyte. This is also thought to involve irreversible binding of lithium, as a result of which the lithium ion battery gradually loses capacity.

WO 2009/033627 discloses a ply which can be used as separator for lithium ion batteries. It comprises a nonwoven and particles which are intercalated into the nonwoven and consist of organic polymers and possibly partly of inorganic material. Such separators can avoid short circuits caused by metal dendrites. However, WO 2009/033627 does not disclose any long-term cycling experiments.

WO 2011/024149 discloses lithium ion batteries which comprise an alkali metal such as lithium between cathode and anode, which acts as a scavenger of unwanted by-products or impurities. Both in the course of production of secondary battery cells and in the course of later recycling of the spent cells, suitable safety precautions have to be taken due to the presence of highly reactive alkali metal.

It was thus an object of the present invention to provide electrical cells which have an improved lifetime and in which, even after several cycles, no deposition of elemental manganese is observed, or in the course of whose production it is possible to use a scavenger which has a lower level of safety problems than the alkali metals and prolongs the lifetime of the cell to the desired degree.

This object is achieved by an electrochemical cell defined at the outset, which comprises
(A) at least one cathode comprising at least one lithium ion-containing transition metal compound,
(B) at least one anode, and
(C) at least one layer comprising
   (a) at least one polymer comprising monomer units comprising nitrogen-containing 5- or 6-membered heterocyclic aromatic structural units or comprising an organic radical which derives from α-aminophosphonic acid or from iminodiacetic acid, and
   (b) optionally at least one binder.

The cathode (A) comprises at least one lithium ion-containing transition metal compound, for example the transition metal compounds LiCoO₂, LiFePO₄ or lithium-manganese spinel which are known to the person skilled in the art in lithium ion battery technology. The cathode (A) preferably comprises, as the lithium ion-containing transition metal compound, a lithium ion-containing transition metal oxide which comprises manganese as the transition metal.

Lithium ion-containing transition metal oxides which comprise manganese as the transition metal are understood in the context of the present invention to mean not only those oxides which have at least one transition metal in cationic form, but also those which have at least two transition metal oxides in cationic form. In addition, in the context of the present invention, the term “lithium ion-containing transition metal oxides” also comprises those compounds which—as well as lithium—comprise at least one non-transition metal in cationic form, for example aluminum or calcium.

In a preferred embodiment, manganese may occur in cathode (A) in the formal oxidation state of +4. Manganese in cathode (A) more preferably occurs in a formal oxidation state in the range from +3.5 to +4.

Many elements are ubiquitous. For example, sodium, potassium and chloride are detectable in certain very small proportions in virtually all inorganic materials. In the context of the present invention, proportions of less than 0.1% by weight of cations or anions are disregarded. Any lithium ion-containing mixed transition metal oxide comprising less than 0.1% by weight of sodium is thus considered to be sodium-free in the context of the present invention. Correspondingly, any lithium ion-containing mixed transition metal oxide comprising less than 0.1% by weight of sulfate ions is considered to be sulfate-free in the context of the present invention.

In one embodiment of the present invention, lithium ion-containing transition metal oxide is a mixed transition metal oxide comprising not only manganese but at least one further transition metal.

In one embodiment of the present invention, lithium ion-containing transition metal compound is selected from manganese-containing lithium iron phosphates and preferably from manganese-containing spinels and manganese-containing transition metal oxides with layer structure, especially manganese-containing mixed transition metal oxides with layer structure.

In one embodiment of the present invention, lithium ion-containing transition metal compound is selected from those compounds having a superstoichiometric proportion of lithium.

In one embodiment of the present invention, manganese-containing spinels are selected from those of the general formula (I)

LiₐMi¹_{b}Mn_{3-a-b}O_{4-d} (I)

where the variables are each defined as follows:
0.9≦a≦1.3, preferably 0.95≦a≦1.15,
0≦b≦0.6, for example 0.0 or 0.5,
where, in the case that M¹ selected=Ni, preferably: 0.4≦b≦0.55,
−0.1≦d≦0.4, preferably 0≦d≦0.1.

M¹ is selected from one or more elements selected from Al, Mg, Ca, Na, B, Mo, W and transition metals of the first period of the Periodic Table of the Elements. M¹ is preferably selected from Ni, Co, Cr, Zn, Al, and M¹ is most preferably Ni.

In one embodiment of the present invention, manganese-containing spinels are selected from those of the formula LiNi_{0.5}Mn_{1.5}O₄₋₃ and LiMn₂O₄.

In another embodiment of the present invention, manganese-containing transition metal oxides with layer structure are selected from those of the formula (II)

Li₁₊ₜM²₁₋ₜO₂ (II)

where the variables are each defined as follows:
0≦t≦0.3 and
M² is selected from AI, Mg, B, Mo, W, Na, Ca and transition metals of the first period of the Periodic Table of the Elements, the transition metal or at least one transition metal being manganese.

In one embodiment of the present invention, at least 30 mol % of M² is selected from manganese, preferably at least 35 mol %, based on the total content of M².

In one embodiment of the present invention, M² is selected from combinations of Ni, Co and Mn which do not comprise any further elements in significant amounts.

In another embodiment, M² is selected from combinations of Ni, Co and Mn which comprise at least one further element in significant amounts, for example in the range from 1 to 10 mol % of AI, Ca or Na.

In one embodiment of the present invention, manganese-containing transition metal oxides with layer structure are selected from those in which M² is selected from Ni_{0.33}Co_{0.33}Mn_{0.33}, Ni_{0.5}Cu_{0.2}Mn_{0.3}, Ni_{0.4}Co_{0.3}Mn_{0.4}, Ni_{0.4}Co_{0.2}Mn_{0.4} and Ni_{0.45}Co_{0.10}Mn_{0.45}.

In one embodiment, lithium-containing transition metal oxide is in the form of primary particles agglomerated to spherical secondary particles, the mean particle diameter (D50) of the primary particles being in the range from 50 nm to 2 μm and the mean particle diameter (D50) of the secondary particles being in the range from 2 μm to 50 μm.

Cathode (A) may comprise one or further constituents. For example, cathode (A) may comprise carbon in a conductive polymorph, for example selected from graphite, carbon black, carbon nanotubes, graphene or mixtures of at least two of the aforementioned substances.

In addition, cathode (A) may comprise one or more binders, for example one or more organic polymers. Suitable binders are, for example, organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene, especially styrene-butadiene copolymers. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers, but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example a-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (A) may have further constituents customary per se, for example an output conductor, which may be configured in the form of a metal wire, metal grid, metal mesh, expanded metal, metal sheet or metal foil. Suitable metal foils are especially aluminum foils.

In one embodiment of the present invention, cathode (A) has a thickness in the range from 25 to 200 μm, preferably from 30 to 100 μm, based on the thickness without output conductor.

Inventive electrochemical cells further comprise at least one anode (B).

In one embodiment of the present invention, anode (B) can be selected from anodes composed of carbon and anodes comprising Sn or Si. Anodes composed of carbon can be selected, for example, from hard carbon, soft carbon, graphene, graphite, and especially graphite, intercalated graphite and mixtures of two or more of the aforementioned carbons. Anodes comprising Sn or Si can be selected, for example, from nanoparticulate Si or Sn powder, Si or Sn fibers, carbon-Si or carbon-Sn composite materials, and Si-metal or Sn-metal alloys.

Anode (B) may have one or more binders. The binder selected may be one or more of the aforementioned binders specified in the context of the description of cathode (A).

In addition, anode (B) may have further constituents customary per se, for example an output conductor which may be configured in the form of a metal wire, metal grid, metal mesh, expanded metal, or metal foil or metal sheet. Suitable metal foils are especially copper foils.

In one embodiment of the present invention, cathode (B) has a thickness in the range from 15 to 200 μm, preferably from 30 to 100 μm, based on the thickness without output conductor.

Inventive electrochemical cells further comprise (C) at least one layer, also called layer (C) for short, comprising (a) at least one polymer, also called polymer (a) for short, comprising monomer units comprising nitrogen-containing 5- or 6-membered heterocyclic aromatic structural units or comprising an organic radical which derives from α-aminophosphonic acid or from iminodiacetic acid, and comprising (b) optionally at least one binder, also called binder (b) for short.

Nitrogen-containing 5- or 6-membered heterocyclic aromatic structural units are known in principle to those skilled in the art. They may be monovalent or polyvalent, for example di- or trivalent, monocyclic or polycyclic, substituted or unsubstituted structural units. Examples of such structural units are

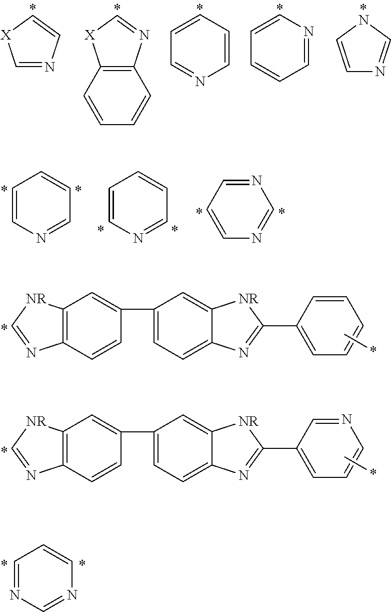

where the atom marked by * indicates the site through which the structural unit is incorporated into the polymer. Preference is given to imidazolyl as a structural unit. Monovalent structural units can be bonded to a polymer backbone directly or via a divalent bonding element, while divalent structural units can be incorporated into a polymer backbone.

In a preferred embodiment of the present invention, the polymer (a) which is present in layer (C) and which comprises monomer units comprising nitrogen-containing 5- or 6-membered heterocyclic aromatic structural units or comprising an organic radical which derives from α-aminophosphonic acid or from iminodiacetic acid, those monomer units selected from the group of monomer units consisting of

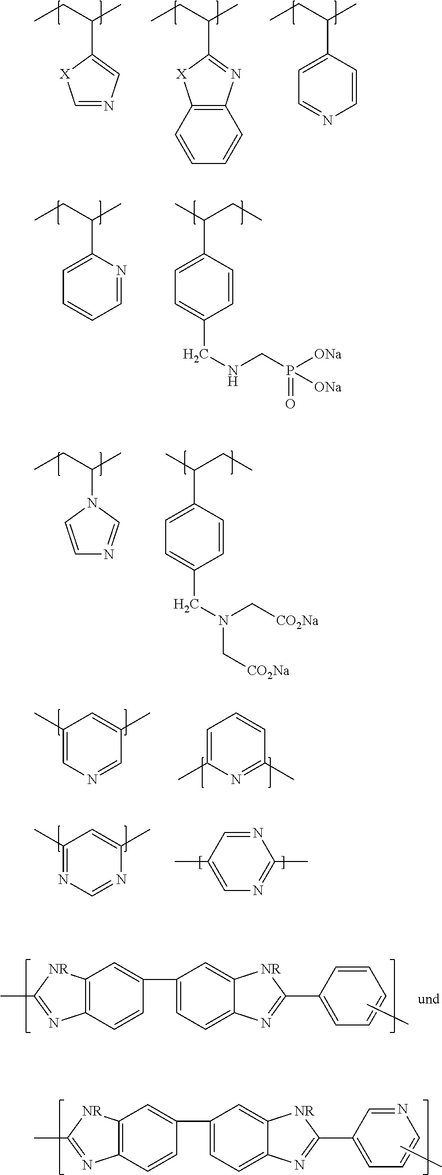

in which X is O, S or NR and R is hydrogen or a C₁-C₄ alkyl radical such as methyl, ethyl, n-propyl or n-butyl.

In a particularly preferred embodiment, the monomer unit is N-vinylimidazole.

The polymer (a) present in layer (C) may be a homopolymer which in each case comprises only one monomer unit comprising a nitrogen-containing 5- or 6-membered heterocyclic aromatic structural unit or comprising an organic radical which derives from α-aminophosphonic acid or from iminodiacetic acid. In addition, the polymer (a) present in layer (C) may be a copolymer which, as well as the at least one monomer unit comprising a nitrogen-containing 5- or 6-membered heterocyclic aromatic structural unit or comprising an organic radical which derives from α-aminophosphonic acid or from iminodiacetic acid, comprises at least one further monomer unit. The further monomer unit of the copolymer may in principle be any known monomer unit copolymerizable together with the former monomer unit.

The polymer (a) present in layer (C) may comprise the monomer units comprising the nitrogen-containing 5- or 6-membered heterocyclic aromatic structural units or comprising an organic radical which derives from α-aminophosphonic acid or from iminodiacetic acid in a proportion of 0.5% by weight up to 100% by weight, preferably of at least 5% by weight, more preferably of at least 20% by weight, even more preferably of at least 40% by weight and especially of at least 50% by weight, based on the total mass of the polymer (a).

In a preferred embodiment of the present invention, the polymer (a) present in layer (C) is a copolymer comprising the monomer units of N-vinylimidazole and N-vinyl-2-pyrrolidinone. Copolymers comprising N-vinylimidazole and N-vinyl-2-pyrrolidinone are known. For example, a crosslinked copolymer comprising N-vinylimidazole and N-vinyl-2-pyrrolidinone is commercially available as Divergan® HM from BASF, and is insoluble in all standard solvents. However, solutions of copolymers comprising N-vinyl-2-pyrrolidinone and N-vinylimidazole are also commercially available, for example Sokalan® HP 56 K or Sokalan® HP 66 K from BASF.

According to the properties of the polymer (a) which is present in layer (C) and has been discussed above, this polymer may be present in layer (C) in different forms. An insoluble polymer such as the crosslinked copolymer Divergan® HM from BASF is preferably incorporated into layer (C) in the form of particles, while a corresponding soluble polymer can be processed to a film or else applied homogeneously in layer (C), for example on or in a carrier material which may be of organic or inorganic origin. For example, the separators described in WO 2009/033627 or constituents thereof can be treated, for example impregnated or sprayed, with a solution of a copolymer comprising N-vinyl-2-pyrrolidinone and N-vinylimidazole, for example a solution of Sokalan® HP 66 K or Luvitec® VPI 55 K 72 W, in order to arrive at a modified separator with which an inventive electrochemical cell can be produced. It is also possible to use polymer (a) in particulate form together with the inorganic or organic particles used in WO 2009/033627 for production of correspondingly modified nonwovens. Also likewise possible is the chemical attachment of a first polymer (a) or of a monomer unit comprising nitrogen-containing 5- or 6-membered heterocyclic aromatic structural units or comprising an organic radical which derives from α-aminophosphonic acid or from iminodiacetic acid to a further polymer, in order to arrive at novel polymers (a) by grafting techniques, for example by grafting of vinylimidazole onto an aromatic polyether ketone or by grafting of a copolymer of N-vinyl-2-pyrrolidinone and N-vinylimidazole onto polyethylene glycol.

In one embodiment of the present invention, in the inventive electrochemical cells, the polymer present in layer (C) is in particulate form, in the form of a film or homogeneously distributed in layer (C). Preferably, the polymer present in layer (C) is in particulate form. Polymers in particulate form may, in the context of the present invention, have a mean particle diameter (D50) in the range from 0.05 to 100 μm, preferably 0.5 to 10 μm, more preferably 2 to 6 μm.

The proportion by weight of polymer (a) in the total mass of layer (C) may be up to 100% by weight. Preferably, the proportion by weight of polymer (a) in the total mass of layer (C) is at least 5% by weight, more preferably 40 to 80% by weight; the proportion by weight of polymer (a) in the total mass of layer (C) is especially in the range from 30 to 50% by weight.

In one embodiment of the present invention, binder (b) is selected from those binders as described in connection with binders for the cathode(s) (A).

In a preferred embodiment of the present invention, layer (C) comprises a binder (b) selected from the group of polymers consisting of polyvinyl alcohol, styrene-butadiene rubber, polyacrylonitrile, carboxymethylcellulose and fluorinated (co)polymers, especially selected from styrene-butadiene rubber and fluorinated (co)polymers.

In one embodiment of the present invention, binder (b) and binder for cathode and for anode, if present, are each the same.

In another embodiment, binder (b) differs from binder for cathode (A) and/or binder for anode (B), or binder for anode (B) and binder for cathode (A) are different.

In one embodiment of the present invention, layer (C) has a mean thickness in the range from 0.1 μm to 250 μm, preferably from 1 μm to 100 μm and more preferably from 5 μm to 30 μm.

Layer (C) is preferably a layer which does not conduct electrical current, i.e. an electrical insulator. Secondly, layer (C) is preferably a layer which permits the migration of ions, especially of Li⁺ ions. Preferably, layer (C), within the inventive electrochemical cell, is arranged spatially between cathode and anode.

In electrochemical cells, the direct contact of the anode with the cathode, which causes a short circuit, is typically prevented by the incorporation of a separator.

In a further embodiment of the present invention, in the inventive electrochemical cells, layer (C) is a separator.

Layer (C) may, as well as the polymer (a) and the optional binder (b), have further constituents, for example support materials such as fibers or nonwovens which ensure improved stability of layer (C), without impairing the necessary porosity and ion perviosity thereof. Alternatively or additionally, layer (C) may also comprise at least one porous polymer layer, for example a polyolefin membrane, especially a polyethylene or polypropylene membrane. Polyolefin membranes may in turn be formed from one or more layers. Porous polyolefin membranes or else nonwovens themselves can generally fulfill the function of a separator on their own. Layer (C) may likewise comprise particles which are inorganic or organic in nature and which are specified, for example, in WO 2009/033627.

In one embodiment of the present invention, in the inventive electrochemical cells, layer (C) additionally comprises a nonwoven (c).

Nonwoven (c) may have been produced from inorganic or organic materials.

Examples of organic nonwovens are polyester nonwovens, especially polyethylene terephthalate nonwovens (PET nonwovens), polybutylene terephthalate nonwovens (PBT nonwovens), polyimide nonwovens, polyethylene and polypropylene nonwovens, PVdF nonwovens and PTFE nonwovens.

Examples of inorganic nonwovens are glass fiber nonwovens and ceramic fiber nonwovens.

According to the composition of layer (C), it may consist, for example, solely of polymer (a), for example a porous film of polymer (a), or of polymer (a) in particulate form and a binder (b) or else of a polyester nonwoven with particles of polymer (a) distributed homogeneously therein. In these cases, layer (C) may itself already be used as a separator in the inventive electrochemical cell and can thus cover the cathode (A) or the anode (B) on at least one side. In addition, a layer (C) may also be applied to a customarily usable battery separator, such as a porous polyolefin membrane or a nonwoven, such that layer (C) covers a separator on at least one side. Layer (C) can also be applied as a thin layer to cathode or anode and the inventive electrochemical cell produced thereby may additionally comprise a porous polyolefin membrane as a separator.

In a further embodiment of the present invention, in the inventive electrochemical cells layer (C) covers the cathode (A) or a separator or the anode (B) on at least one side.

The present invention further provides for the use of a polymer (a), as described above, comprising monomer units comprising 5- or 6-membered heterocyclic aromatic structural units or comprising an organic radical which derives from α-aminophosphonic acid or from iminodiacetic acid for production of an electrochemical cell, especially an inventive electrochemical cell, as described above.

The layer (C) present in the inventive electrochemical cell may, depending on the structure thereof, also be produced as a semifinished product independently of the assembly of the inventive electrochemical cell, and be incorporated at a later stage in an electrochemical cell between cathode and anode by a battery manufacturer as part of an electrochemical cell, for example as a finished separator or together with a typical battery separator, such as a PET nonwoven or a porous polyolefin membrane.

Inventive electrochemical cells may also have constituents customary per se, for example conductive salt, nonaqueous solvent, and also cable connections and housing.

In one embodiment of the present invention, inventive electrochemical cells comprise at least one nonaqueous solvent which may be liquid or solid at room temperature and is preferably liquid at room temperature, and which is preferably selected from polymers, cyclic or noncyclic ethers, cyclic or noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably di-methyl- or -ethyl-end capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

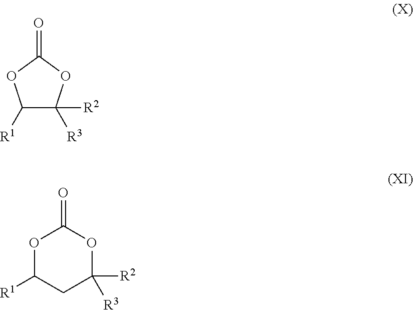

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

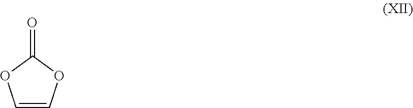

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂ where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Inventive electrochemical cells further comprise a housing which may be of any shape, for example cuboidal or in the shape of a cylinder. In another embodiment, inventive electrochemical cells have the shape of a prism. In one variant, the housing used is a metal-plastic composite film processed as a pouch.

Inventive electrochemical cells give a high voltage of up to approx. 4.8 V and are notable for high energy density and good stability. More particularly, inventive electrochemical cells are notable for only a very small loss of capacity in the course of repeated cycling.

The present invention further provides for the use of inventive electrochemical cells in lithium ion batteries. The present invention further provides lithium ion batteries comprising at least one inventive electrochemical cell. Inventive electrochemical cells can be combined with one another in inventive lithium ion batteries, for example in series connection or in parallel connection. Series connection is preferred.

The present invention further provides for the use of inventive electrochemical cells as described above in motor vehicles, bicycles operated by electric motor, aircraft, ships or stationary energy stores.

The present invention therefore also further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive lithium ion batteries in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The invention is explained by the examples which follow but do not limit the invention.

Figures in % are each based on % by weight, unless explicitly stated otherwise,

### I.1 Production of an Inventive Separator (S.1)

A crosslinked copolymer of vinylpyrrolidone (VP) and N-vinylimidazole (VI) in a ratio of 10:90 (Divergan® HM from BASF) was comminuted in an AFG fluidized bed counter-jet mill to particle sizes of less than 8 μm (>10=1.2 μm, ×50=4.7 μm, ×90=7.9 μm). The particle size distribution was determined by means of laser diffraction technology in powder form with a Mastersizer from Malvern Instruments GmbH, Herrenberg, Germany.

Disks of diameter 13 mm were punched out of a glass fiber nonwoven (Whatman, 260 μm thickness) and dried in a drying cabinet at 120° C. for several hours. Thereafter, the glass fiber nonwoven disks were transferred to an argon-filled glovebox. Each glass fiber nonwoven disk was divided into two parts, such that one glass fiber nonwoven disk of thickness 260 μm gave two glass fiber nonwoven disks each of thickness approx. 130 μm. The previously ground crosslinked copolymer of VI and VP (90:10) (Divergan® HM) was distributed homogeneously over the full area between the two glass fiber disks, so as to form a glass fiber nonwoven/Divergan® HM/glass fiber nonwoven sandwich having, for instance, a relative area coverage of Divergan® HM of approx. 5-10 mg/cm².

### I.2 Production of an Inventive Separator (S.2)

An aqueous solution of an uncrosslinked copolymer of vinylpyrrolidone and N-vinylimidazole in a ratio of 45:55 (Luvitec® VPI 55 K 72 W from BASF) was concentrated by evaporation in a drying cabinet at 40° C. overnight. The residue was coarsely comminuted with a mortar and pestle and then dried in an evacuated desiccator over P₂O₅ for 2 days. The dried residue was finely ground under argon protective gas with an agate mortar until the particle size was below approx. 20 μm. Disks of diameter 13 mm were punched out of a glass fiber nonwoven (Whatman, 260 μm thickness) and dried in a drying cabinet at 120° C. for several hours. Thereafter, the glass fiber nonwoven disks were transferred to an argon-filled glovebox. Each glass fiber nonwoven disk was divided into two parts, such that one glass fiber nonwoven disk of thickness 260 μm gave two glass fiber nonwoven disks each of thickness approx. 130 μm. The previously ground Luvitec® VPI 55 K 72 W was distributed homogeneously over the full area between the two glass fiber disks, so as to form a glass fiber nonwoven/Luvitec® VPI 55 K 72 W/glass fiber nonwoven sandwich having, for instance, a relative area coverage of Luvitec® VPI 55 K 72 W of approx. 5-10 mg/cm².

### I.3 Production of an Inventive Separator (S.3)

1.9 g of the fine Divergan® HM produced beforehand from example 1.1 were combined with 0.2 g of a 50% by weight aqueous emulsion of a styrene-butadiene rubber (average particle size: 190 nm; glass transition temperature: −10° C.; binder 20-01) and 8 ml of water to give a stirrable suspension, and stirred for approx. 1 h. The suspension thus obtained was knife-coated homogeneously onto a PET nonwoven, commercially available as “PES20” nonwoven from APODIS Filtertechnik OHG, and the coated nonwoven was dried at room temperature overnight. After drying, a nonwoven was obtained with a Divergan® HM coverage of in each case approx. 5-10 mg/cm². Thereafter, disks of diameter 13 mm were punched out and dried once again in a vacuum drying cabinet at 120° C. for 16 hours. Subsequently, these disks were transferred to an argon-filled glovebox.

### I.4 Production of a Noninventive Separator (C-S.4)

The experiment from example I.1 or I.2 was repeated analogously under the same conditions, except that the glass fiber nonwoven was not now filled with Divergan® HM or Luvitec® VPI 55 K 72 W, but instead used unchanged, in order to obtain comparative separator C-S.4.

### I.5 Production of a Noninventive Separator (C-S.5)

The experiment from example I.3 was repeated under the same conditions, except that the PET nonwoven was not coated with Divergan® HM, but instead used unchanged, in order to obtain comparative separator C-S.5.

### II. Production of Electrochemical Cells and Testing Thereof

The following electrodes were always used:

Cathode (A.1): a lithium-nickel-manganese spinel electrode was used in each case, which was produced as follows. The following were mixed with one another in a screw-top vessel:

### 85% LiMn_{1.5}Ni_{0.5}O₄

6% PVdF, commercially available as Kynar Flex® 2801 from Arkema Group,
6% carbon black, BET surface area 62 m²/g, commercially available as “Super P Li” from Timcal,
3% graphite, commercially available as KS6 from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick aluminum foil and dried in a vacuum drying cabinet at 120° C. for 16 hours. The thickness of the coating after drying was 30 μm. Subsequently, circular disk-shaped segments were punched out, diameter: 12 mm.

Anode (B.1): The following were mixed with one another in a screw-top vessel:
91% graphite, ConocoPhillips C5,
6% PVdF, commercially available as Kynar Flex® 2801 from Arkema Group,
3% carbon black, BET surface area 62 m²/g, commercially available as “Super P Li” from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick copper foil and dried in a vacuum drying cabinet at 120° C. for 16 hours. The thickness of the coating after drying was 35 μm. Subsequently, circular disk-shaped segments were punched out, diameter: 12 mm.

The following electrolyte was always used:

1 M solution of LiPF₆ in anhydrous ethylene carbonate-ethyl methyl carbonate mixture (proportions by weight 1:1)

### II.1 Production of an Inventive Electrochemical Cell EC.1 and Testing

In an argon-filled glovebox, electrolyte was dripped onto the inventive separator (S.1) produced according to 1.1 and it was positioned between a cathode (A.1) and an anode (B.1) such that both the anode and the cathode had direct contact with the separator. This gave inventive electrochemical cell EC.1. The electrochemical analysis was effected between 4.25 V and 4.8 V in Swagelok cells.

The first two cycles were run at 0.2 C rate for the purpose of forming; cycles no. 3 to no. 50 were cycled at 1 C rate, followed again by 2 cycles at 0.2 C rate, followed by 48 cycles at 1 C rate, etc. The charging and discharging of the cell was performed with the aid of a “MACCOR Battery Tester” at room temperature.

It was found that the battery capacity remained very stable over the course of the repeated charging and discharging.

II.2 to II.5 Production of electrochemical cells EC.2, EC.3, and C-EC.4, C-EC.5, and testing

Analogously to Example II.1, separators S.2, S.3, and C-S.4 and C-S.5, were used to produce electrochemical cells EC.2, EC.3, and C-EC.4 and C-EC.5, and they were tested correspondingly.

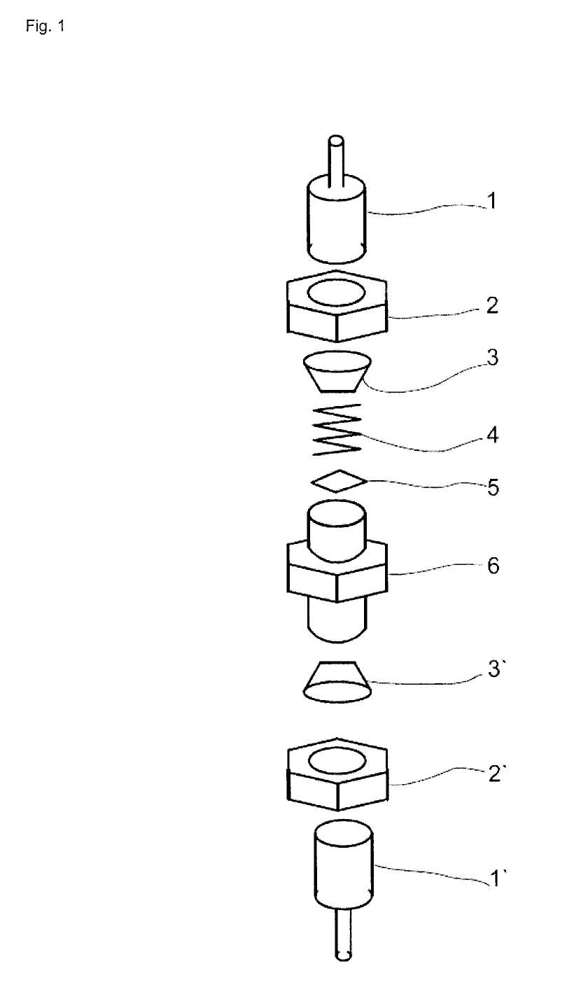

FIG. 1 shows the schematic structure of a dismantled electrochemical cell for testing of inventive and noninventive separators.

The annotations in FIG. 1 mean:
1, 1′ die
2, 2′ nut
3, 3′ sealing ring—two in each case; the second, somewhat smaller sealing ring in each case is not shown here
4 spiral spring
5 nickel output conductor
6 housing

### Results:

Electrochemical cell EC.1 was charged and discharged in a very stable manner over 160 cycles and lost only 27% of the start capacity after 130 cycles.

Electrochemical cell EC.2 was charged and discharged in a very stable manner over 160 cycles and lost only 11% of the start capacity after 130 cycles.

Electrochemical cell EC.2 was charged and discharged in a very stable manner over 160 cycles and lost only 14% of the start capacity after 130 cycles.

Electrochemical cells C-EC.4 from the comparative example degraded relatively significantly and lost 46% of the start capacity after about 130 cycles.

Electrochemical cells C-EC.5 from the comparative example degraded relatively significantly and likewise lost 46% of the start capacity after about 130 cycles.

1. An electrochemical cell comprising
(A) at least one cathode comprising at least one lithium ion-containing transition metal compound,
(B) at least one anode, and
(C) at least one layer comprising
(a) at least one polymer comprising monomer units comprising nitrogen-containing 5- or 6-membered heterocyclic aromatic structural units or comprising an organic radical which derives from α-aminophosphonic acid or from iminodiacetic acid, and
(b) optionally at least one binder.

2. The electrochemical cell according to claim 1, wherein lithium ion-containing transition metal compound is selected from manganese-containing spinels and manganese-containing transition metal oxides with layer structure.

3. The electrochemical cell according to claim 1 or 2, wherein anode (B) is selected from anodes composed of carbon and anodes comprising Sn or Si.

4. The electrochemical cell according to any of claims 1 to 3, wherein the polymer present in layer (C) comprises monomer units selected from the group of monomer units consisting of 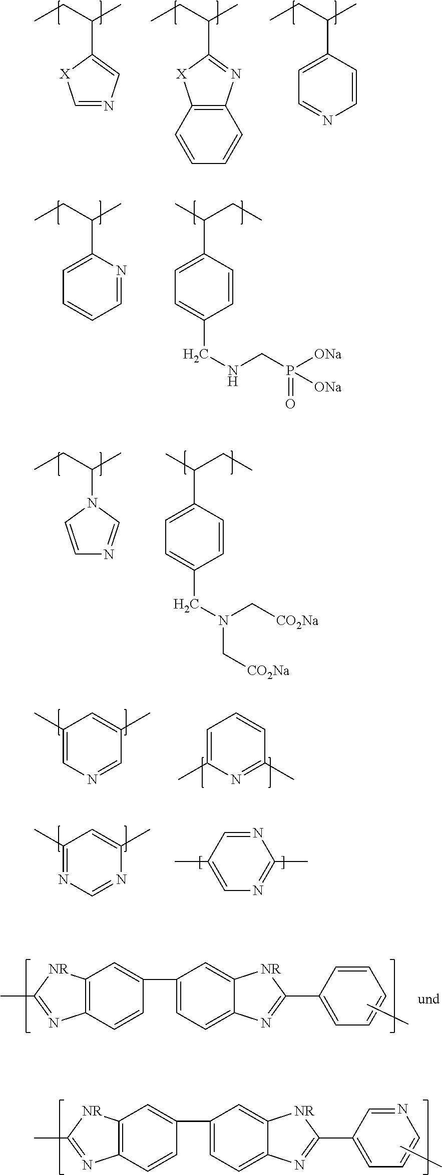
in which X is O, S or NR and R is hydrogen or a C₁-C₄ alkyl radical.

5. The electrochemical cell according to any of claims 1 to 3, wherein the polymer present in layer (C) is a copolymer comprising the monomer units of N-vinylimidazole and N-vinyl-2-pyrrolidinone.

6. The electrochemical cell according to any of claims 1 to 5, wherein the polymer present in layer (C) is in particulate form, in the form of a film oder homogeneously distributed in layer (C).

7. The electrochemical cell according to any of claims 1 to 6, wherein layer (C) comprises a binder (b) selected from the group of polymers consisting of polyvinyl alcohol, styrene-butadiene rubber, polyacrylonitrile, carboxymethylcellulose and fluorinated (co)polymers.

8. The electrochemical cell according to any of claims 1 to 7, wherein layer (C) has a mean thickness in the range from 9 to 50 μm.

9. The electrochemical cell according to any of claims 1 to 8, wherein layer (C) is a separator.

10. The electrochemical cell according to any of claims 1 to 9, wherein layer (C) additionally comprises a nonwoven (c).

11. The electrochemical cell according to any of claims 1 to 10, wherein layer (C) covers the cathode (A) or a separator or the anode (B) on at least one side.

12. The use of electrochemical cells according to any of claims 1 to 11 in lithium ion batteries.

13. A lithium ion battery comprising at least one electrochemical cell according to any of claims 1 to 11.

14. The use of electrochemical cells according to any of claims 1 to 11 in motor vehicles, bicycles operated by electric motor, aircraft, ships or stationary energy stores.

15. The use of a polymer comprising monomer units comprising nitrogen-containing 5- or 6-membered heterocyclic aromatic structural units or comprising an organic radical which derives from α-aminophosphonic acid or from iminodiacetic acid for production of an electrochemical cell.
